(19) United States
(12) Patent Application Publication
(10) Pub. No.: US 2007/0272744 A1
(43) Pub. Date: Nov. 29, 2007

(54) Detection and visualization of patterns and associations in access card data

(75) Inventors: Venkataramana Kini Bantwal, Bangalore (IN); Lokesh R. Boregowda, Bangalore (IN); Lokesh T. Siddaramanna, Karnataka (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/439,773

(22) Filed: May 24, 2006

(51) Int. Cl. G06K 5/00; G06K 7/10

(52) U.S. Cl. 235/382; 235/377

(57) ABSTRACT

A log file is generated from data supplied by cards readers that are part of an access control system and that read access control cards in connection with restricted areas. Probabilities of card holders entering the restricted areas are computed based on the data in the log file. Unusual access patterns are detected from the data in the log file based on the computed probabilities. Group associations between card holders are detected based on common movement of the card holders in connection with the restricted areas. A new log file is created based on those of the detected unusual access patterns that are not associated with the group associations.

### TECHNICAL FIELD OF THE INVENTION

The present invention relates to the processing of data read from access control cards such as those used in an access control system.

### BACKGROUND OF THE INVENTION

Access control systems are frequently used at various sites to admit only authorized personnel into restricted areas. The restricted areas can include offices, floors, groups of floors, a building or buildings, or any other areas which contain sensitive material.

An access control system typically uses access control cards employed by authorized personnel (card holders) who present their access control cards to a reader in order to gain access to restricted areas. An example of an access control card is one that has a magnetic stripe that is read by the reader (in this case, a magnetic reader) when the card holder swipes a card through a reader or otherwise places the card near enough to the reader to be read. However, other types of access control cards are known. For example, access control cards can be based on proximity sensing and/or can be smart cards. Access control cards have been used at various places of restricted entry such as in offices, national research institutes and/or laboratories, defense establishments, residential and commercial buildings, etc.

The readers in access control systems log a substantial amount of information as card holders, using their access control cards, enter and leave restricted areas. The present invention is directed to an arrangement in which this information is processed to detect unusual patterns that may tend to indicate suspicious behavior.

### SUMMARY OF THE INVENTION

In accordance with one aspect of the present invention, a computer implemented method is provided to processing access control data generated in connection with access control cards. The method comprises the following: reading a log file containing data generated by an access control system that reads the access control cards in connection with restricted areas; and, detecting unusual access patterns from the data in the log file.

In accordance with another aspect of the present invention, a computer readable storage medium has program code stored thereon, and the program code when executed performs the following functions: generating a log file from data supplied by cards readers that read access control cards in connection with restricted areas; computing probabilities of card holders entering the restricted areas, wherein the probabilities are computed based on the data in the log file; and, detecting unusual access patterns based on the computed probabilities.

In accordance with yet another aspect of the present invention, a computer implemented method is provided to process access control data generated in connection with access control cards. The method comprises the following: generating a log file from the access control data supplied by cards readers that read the access control cards in connection with restricted areas; computing probabilities of card holders entering the restricted areas, wherein the probabilities are computed based on the data in the log file; detecting unusual access patterns from the data in the log file based on the computed probabilities; detecting group associations between card holders based on common movement of the card holders in connection with the restricted areas; and, creating a new log file based on the detected unusual access patterns that are not associated with the group associations.

### BRIEF DESCRIPTION OF THE DRAWINGS

These and other features and advantages will become more apparent from a detailed consideration of the invention when taken in conjunction with the drawings in which:

FIG. 1 illustrates an access control system which provides an example of an environment for the present invention;

FIG. 2 shows a high level flow chart of a program that can be executed by the controller of FIG. 1 to detect unusual patterns in the access control data stored in the log file maintained by the access control system of FIG. 1;

FIG. 3 illustrates an example of a log file that can be maintained by the access control system of FIG. 1;

FIG. 4 illustrates an example of probabilistic data relating to the probabilities of card holders visiting restricted areas;

FIGS. 5A and 5B provide a more detailed showing of the high level flow chart of FIG. 2;

FIG. 6 is a high level flow chart of a program that can be executed by the controller of FIG. 1 in order to detect group associations;

FIG. 7 provides a more detailed showing of the high level flow chart of FIG. 6; and,

FIGS. 8A, 8B, and 8C illustrate an example of a grouping table.

### DETAILED DESCRIPTION

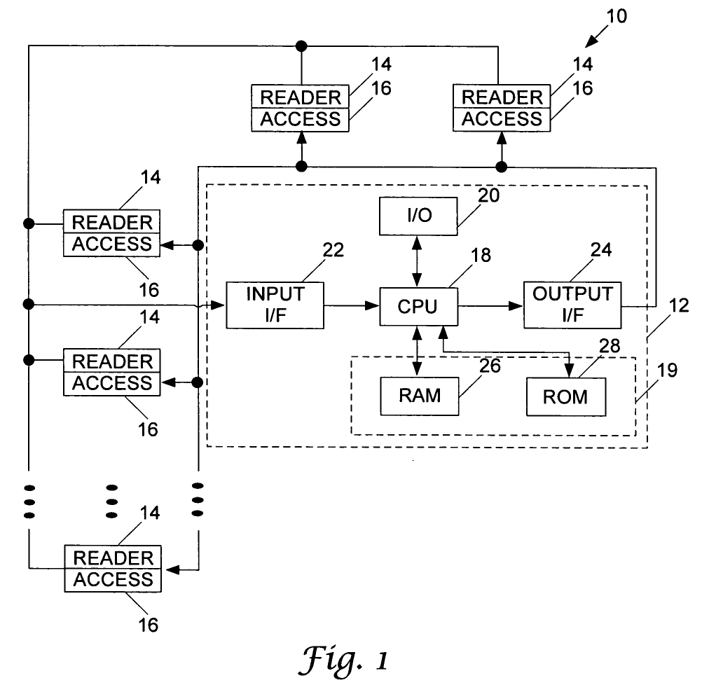

An access control system 10, as shown in FIG. 1, includes a controller 12 that is coupled to a plurality of card readers 14 and to a plurality of access permitting devices 16.

The card readers 14 are located at the portals (such as doorways, gates, etc.) that permit entrance to and exit from restricted areas. For example, some of the readers 14 may be positioned at the doorways leading into and out of a building, some of the readers 14 may be positioned at gates restricting access to elevators, escalators, and other appliances or areas of the building, some of the readers 14 may be positioned at the doorways leading into and out floors of the building, some of the readers 14 may be positioned at the doorways leading into and out of offices or groups of offices of the building, etc. Other locations and arrangements of the readers 14 are, of course, possible.

The readers 14 read identification indicia (referred to herein as IDs) that are stored on the access control cards and that uniquely identify card holders who are authorized access into and/or out of the restricted areas. Such authorization may be selective. For example, some card holders may be authorized to enter some areas of a building but not others. The IDs read by the readers 14 are processed by the controller 12 to determine authenticity of the card holder and to detect unusual patterns from the log data that might indicate suspicious behavior such as fraudulent or improper attempts to enter restricted areas.

Each of the access permitting devices 16 is located at a corresponding portal protected by a corresponding one of the readers 14. The access permitting devices 16, for example, may be locks, gates, etc. that allow authorized card holders to pass through the portals once their access control card IDs have been read and authenticated. The access permitting devices 16 are controlled by the controller 12.

The controller 12 includes components that facilitate processing of the data accumulated from the readers 14 and that facilitate appropriate control of the access permitting devices 16. These components, for example, may include a central processing unit 18 that is coupled to a memory 19, various input/output devices 20, an input interface 22, and an output interface 24. The memory 19 includes a RAM 26 and a ROM 28 and may be used, for example, to store the access control card IDs associated with the card holders who are authorized access to the various restricted spaces. The memory 19 may also be used to store the programming necessary for the proper functioning of the access control system 10, to store log data based on the access control card IDs received from the readers 14, to store the programming permitting the access control system 10 to detect unusual ingress and egress patterns of the card holders, etc.

The input/output devices 20 may include, for example, a keyboard, a mouse, a printer, a display, and/or various ports for the connection of other equipment useful to the access control system 10. The input interface 22 controllably passes inputs from the readers 14, and the output interface 24 controllably passes outputs to the access permitting devices 16.

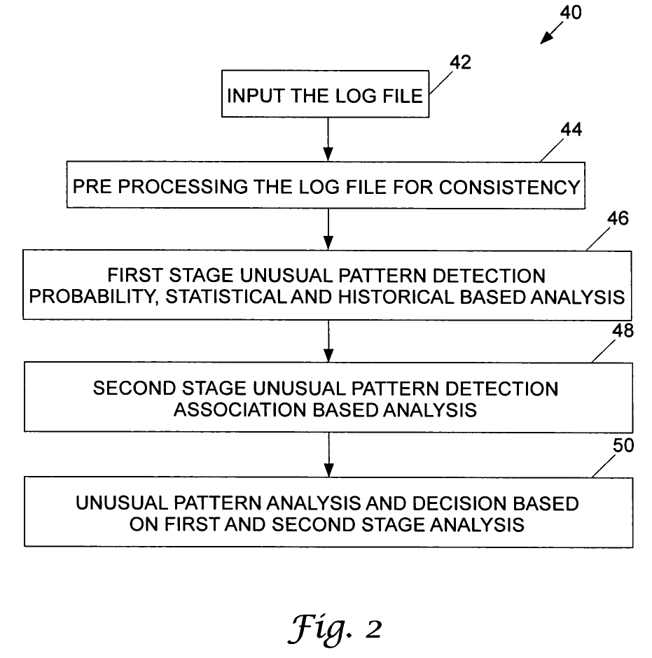

As discussed above, the controller 12 processes data to detect unusual patterns in the data that might indicate fraudulent, improper, or other suspicious behavior of the card holders. In order to detect such unusual data patterns, the controller 12 maintains in the memory 19 an initial log file of the data accumulated from the readers 14 and executes a process, which is shown as a high level process in FIG. 2, in order to detect these unusual data patterns from the data stored in the initial log file. The word “initial” in connection with this log file is used only distinguish it from the new log file discussed below. No other connotation should be given to the use of the word “initial” in connection with this log file.

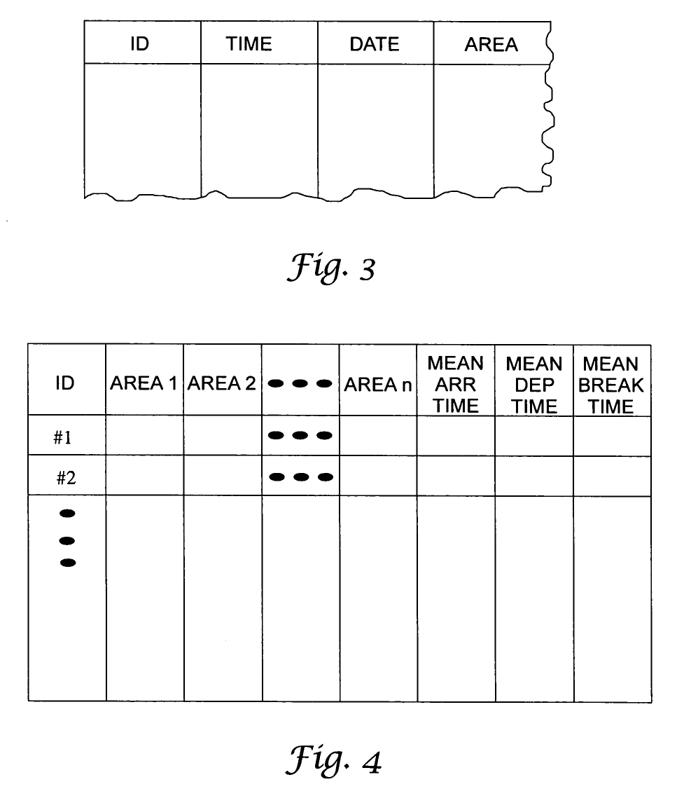

The initial log file stores the access control information derived from information supplied by the readers 14. The initial log file, for example, contains access control card IDs for the card holders who access restricted areas protected by the access control system 10, the times at which the access control cards are read by the readers 14, and an identification of the corresponding restricted areas accessed by the corresponding card holders. Thus, each log entry may have the form shown in FIG. 3.

To the extent that the access control system 10 requires the use of the access control cards to exit as well as to enter restricted areas, and to the extent the readers 14 can distinguish between entering and exiting a restricted area, the time information may be broken down into entrance times (time in) and exit times (time out).

Each row in FIG. 3 contains the access control card ID of a corresponding card holder who is authorized to enter or exit a restricted area, the time at which the card holder entered (or left) a restricted area, the date of the corresponding entry in the initial log file, and an identification of the restricted area into which (or from which) the card holder entered (or left) at the corresponding time. Each time the access control card of a card holder is read by one of the readers 14, an entry is made in a new row of the initial log file of FIG. 3. The log could contain other fields such as the name associated with the access control card ID.

As shown in FIG. 2, the data in the initial log file is input to an unusual pattern recognition program 40 at 42. Before this data is searched for unusual patterns, it may be beneficial to first pre-process the data at 44 so as to remove inconsistencies from the data. For example, duplicate data for the same log entry such as may result from an improper installation of a sensor of an access card reader can be eliminated. Successive IN and OUT entries in the initial log file for the same access control card ID at the same instant in time (which may be due to an improper installation of an access control card reader) can likewise be eliminated.

Also, missing IN and OUT entries in the initial log file may be supplied under certain circumstances. Missing IN and OUT entries can be extrapolated from known data. For example, if the initial log file shows that a card holder has exited a restricted area at his or her usual time in the afternoon of a given day (an OUT entry), but the initial log file shows no IN entry for that card holder on that day, the controller 12 may supply the missing IN entry. Similarly, the controller 12 may supply a missing OUT entry.

A missing IN log entry for the present day can be inserted into the initial log file for an access control card ID if the last log entry of the previous day for that access control card ID is an OUT entry and if the first log entry of the present day for that access control card ID is an OUT entry. The time of the inserted IN log entry for that access control card ID is calculated based on the average of a predetermined number of previous IN times between 7:30 A.M. and 11:30 A.M.

Care must be taken that a missing entry is not itself an indication of an unusual pattern. For example, a number of missing entries suggests unusual behavior.

A missing OUT log entry for the last OUT of the present day can be inserted into the initial log file for an access control card ID if the first entry for the next day is not an OUT entry. The time of the inserted OUT log entry for that access control card ID is calculated based on the average of a predetermined number of previous OUT times between 5:30 P.M. and 9:30 P.M. and on restricted area information based on the IN log entries of the present day.

An IN entry relates to an entrance into a restricted area and an OUT entry relates to an exit from a restricted area. An access control card ID is an identification that is stored on an access control card and that uniquely identifies the holder of the access control card.

Moreover, it may be desirable at 44 to extract only certain fields from the initial log file when creating the new log file discussed more fully below. These fields may pertain to restricted area information, date information, time information, and access control card IDs. The new log file may have a form similar to that shown in FIG. 3 which each row corresponds to an entry and each column corresponds to a field of the entry. For example, each row of the new log file may have a serial number field to identify the particular entry, a restricted area field, a date field, a time field, and an access control card ID field. The name of the card holders need not be included in the new log file because the access control card IDs are sufficient for processing. However, a name field and/or other fields can be included as desired.

Further, the average break times for each access control card ID can be calculated and can be used in the detection of unusual patterns. The typical morning coffee break time can be calculated using the first OUT log entry during the time interval of 10:30 A.M. to 11:45 A.M. The typical lunch break time can be calculated using the first OUT log entry during the time interval of 12:30 P.M. to 2:30 P.M. The typical evening tea break time can be calculated using the first OUT log entry during the time interval of 3:30 P.M. to 4:30 P.M. The number and time intervals used for the calculation of these breaks will depend on local customs.

The detection of unusual patterns may be accomplished, for example, in stages. Two stages are shown in connection with the present invention. However, more or fewer stages can be used.

The first stage at 46 involves finding unusual data patterns using a probabilistic, statistical, and historical approach. In this first stage, the probability of a person visiting a restricted area, such as a floor, is considered. Each visit by a card holder to a restricted area increases the probability that the card holder will in the future visit that restricted area and decreases the probability that the same card holder will visit some other restricted area.

According to an example of an algorithm that may be employed to calculate this probability, the log data for the first x number of days (where x may, for example, be 15) may be used to calculate an initial probability for each restricted area and for each card holder. This calculation of the initial probability is based on the assumption that a card holder who visits a restricted area in an x day pattern will likely visit the same restricted area on days x+1, x+2, etc. This calculation may be made dependent on the position of the card holder in an office.

Thus, a probability PROB that a card holder will visit a restricted area is determined. The probability PROB can be determined, for example, according to the following equation:

$$PROB = \frac{No . of Visits to the restricted Area}{Total No . of Visits to all restricted Areas} \qquad ( 1 )$$

where the numbers of visits in the numerator and denominator of equation (1) are for a corresponding card holder. These initial probabilities may be stored in the initial log file. For example, these initial probabilities may be stored in the tabular form of FIG. 4.

Thus, as shown in FIG. 4, a probability that card holder #1 will visit restricted area #1 is calculated and stored for card holder #1 in connection with restricted area #1, a probability that card holder #1 will visit restricted area #2 is calculated and stored for card holder #1 in connection with restricted area #2, and so on for all other restricted areas covered by the access control system 10. Similarly, a probability that card holder #2 will visit restricted area #1 is calculated and stored for card holder #2 in connection with restricted area #1, a probability that card holder #2 will visit restricted area #2 is calculated and stored for card holder #2 in connection with restricted area #2, and so on for all other restricted areas covered by the access control system 10. Similar probabilities are likewise calculated for all other card holders covered by the access control system 10.

The probabilities stored in the table of FIG. 4 can be further broken down by day part, if desired. For example, a probability of a card holder visiting a restricted area during the morning hours can be calculated and stored in a morning section of the table of FIG. 4, a probability of a card holder visiting a restricted area during the afternoon hours can be calculated and stored in an afternoon section of the table of FIG. 4, and a probability of a card holder visiting a restricted area during the evening hours can be calculated and stored in an evening section of the table of FIG. 4.

As further shown in connection with FIG. 4, the mean arrival time of each card holder is calculated and stored in connection with each card holder, the mean departure time of each card holder is calculated and stored in connection with each card holder, and the mean break times of each card holder are calculated and stored in connection with each card holder. These mean times may be updated daily, weekly, or at any other interval desired by the user. The mean arrival and departure times may be based on the first arrival time and the last departure time of the day, or the mean arrival and departure times may be calculated on a per restricted area basis.

After calculation of the initial probabilities, data for the next y number of days (where y, for example, may be one month) is used to adjust PROB based on subsequent visits to the restricted area. The increase and decrease in PROB may be calculated, for example, as follows:

$$\begin{matrix}PROB Increment = [ 1 - \frac{No . of Visits to the restricted area}{Total no . of visits to all restricted areas} ] Variance & ( 2 ) \\ PROB Decrement = [ ( 1 - \frac{No . of Visits to the restricted area}{Total no . of visits to all restricted areas} ) Variance ] / χ & ( 3 )\end{matrix}$$

where χ=Total Number of restricted areas−1.

Statistics, such as the mean, the standard Deviation, and the variance, are then computed for the data in the initial log file maintained by the controller 12.

Unusual data in the initial log file is then determined from these statistics based on a probabilistic approach, and a new log file is created such that the new log file contains only entries in the initial log file which fall below the probability threshold. This threshold is the square of the variance σ. The variance σ may be calculated in accordance with the following equation:

$${σ}^{2} = \frac{\sum {( X - μ )}^{2}}{N} \qquad ( 4 )$$

where X is the score, μ is the mean or average of the scores, and N is the number of scores.

For example, after the initial 15 days, a particular card holder may have history of visits to different floors as shown in the table below.

| | Card Number |
|---|---|
| | 92821666 |
| Floor | No. of Visits |
| 0 | 5 |
| 1 | 3 |
| 2 | 62 |
| 3 | 1 |
| 4 | 40 |
| 5 | 1 |
| 6 | 4 |
| 7 | 7 |
| 8 | 0 |
| 9 | 0 |

### The floor visiting probabilities for all the floors for the above card number 92821666 can be calculated in accordance with equation 1 and is given in the following table.

| | Card Number | |
|---|---|---|
| | 92821666 | |
| Floor | Number of visits | Probability |
| 0 | 5 | 0.0406504 |
| 1 | 3 | 0.0243902 |
| 2 | 62 | 0.5040650 |
| 3 | 1 | 0.0081300 |
| 4 | 40 | 0.3252032 |
| 5 | 1 | 0.0081300 |
| 6 | 4 | 0.0325203 |
| 7 | 7 | 0.0569105 |
| 8 | 0 | 0 |
| 9 | 0 | 0 |

After the initial days (e.g., 15 days), the probability is updated for each card data, and the variance is re-calculated using the floor probability data.

Further, the duration of a stay in a restricted area for an unusual log entry is also calculated and entered in the new log file. The duration of a stay in the restricted area is calculated only if the next entry in the initial log file for that restricted area and for that access control card ID is an OUT entry; otherwise, this entry in the new log file is marked as NA (not available). If there are no entries in the initial log file for a particular access control card ID, then an entry for that access control card ID is marked in the new log file as ABSENT.

All the entries in the initial log file will be analyzed. If the entry probability of a corresponding entry in the initial log file falls below the calculated threshold, that entry will be separated, will be moved to the new log file, and will be used for the next stage.

Accordingly, the detection of unusual access patterns at 46 can be carried out based on a plurality of criteria. Such criteria can include, for example, (i) visits to less probable areas, floors, or buildings, (ii) visits to less probable areas, floors, or buildings as compared to previous visits, (iii) unusual durations of visits to areas, floors, or buildings, (iv) deviations in arrival times as compared to a mean arrival time, (v) deviations in departure times as compared to a mean departure time, (vi) deviations in break times, etc.

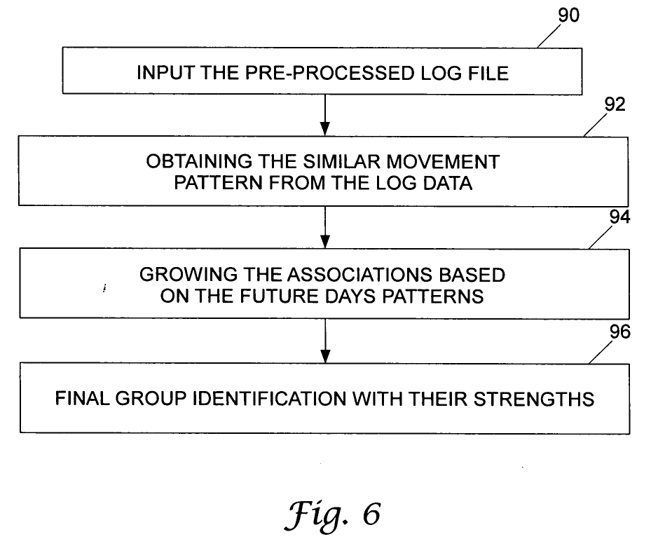

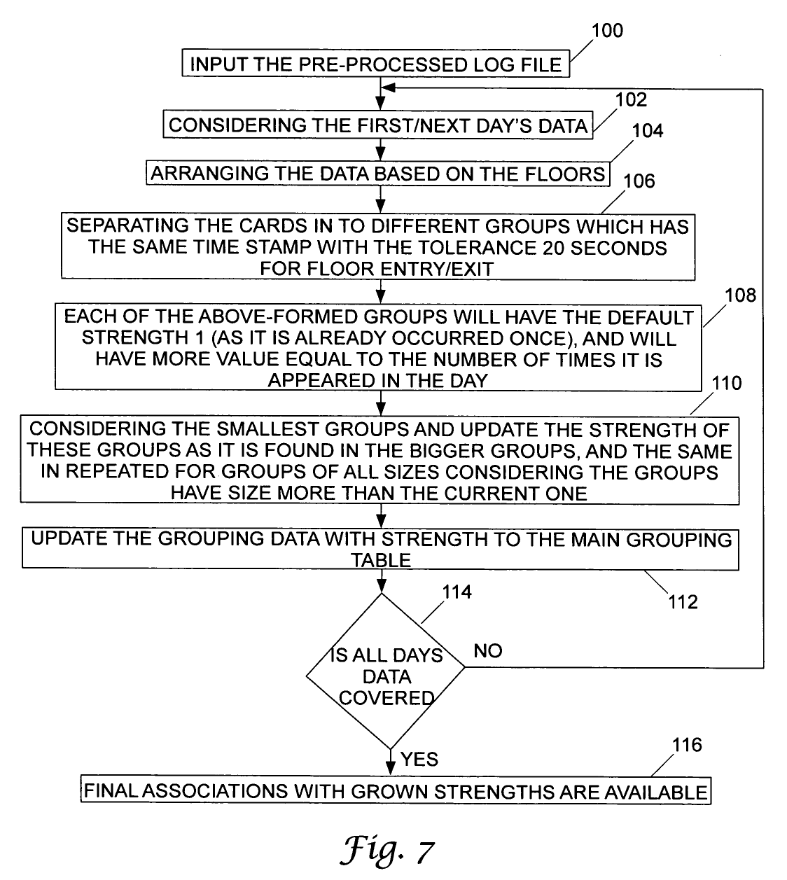

The second stage at 48 of FIG. 2 involves processing the data in the new log file in accordance with associations between people. In this processing, each person who has an entry in the new log file is associated with the people with whom he/she is working. This association information can be extracted from the initial log file. These associations provide information about the relationship between a card holder and his/her co-workers and are extracted as discussed below in connection with FIGS. 6 and 7.

This association information is useful in identifying unusual patterns because, most of the time, co-workers move together when they work on a common team or on a common project. Thus, the data stored in the new log file might not indicate suspicious behavior if a card holder corresponding to an entry in the new log file had been moving with associates in and out of the same restricted areas during the same time periods. Even when the card holder associated with an entry in the new log file does not have IN and OUT entries that precisely match the IN and OUT entries of most or all of the group with which that card holder has moved, such entries might not involve an unusual pattern. In certain cases, the group movement can also be categorized as a unusual pattern.

If the new log file contains IN and OUT times of a card holder of interest that match the IN and OUT times for other card holders involving the same restricted areas, it can be assumed, at least with respect to time periods involving the matching IN and OUT times, that the card holder of interest and the other card holders are moving as a group (i.e., the card holder of interest is associated with a group of other card holders during these time periods).

At 50, the unusual patterns found at 46 and the group associations found at 48 are analyzed in order to detect anomalies in the behavior of card holders. Each of the unusual entries separated out in the first stage at 46 is analyzed for unusual patterns. The time stamp of each entry for each access control card ID is considered within a predetermined tolerance (such as ±15 minutes). Associations between card holders detected at 48 are searched within that time frame. Accordingly, if a card holder has moved with associates within this time frame, the unusual pattern detected at 46 will not be treated as unusual pattern for the purpose of determining suspicious behavior. Hence, such unusual patterns detected at 46 are moved out of the new (unusual) data file. Otherwise, the unusual patterns detected at 46 will be considered suspicious.

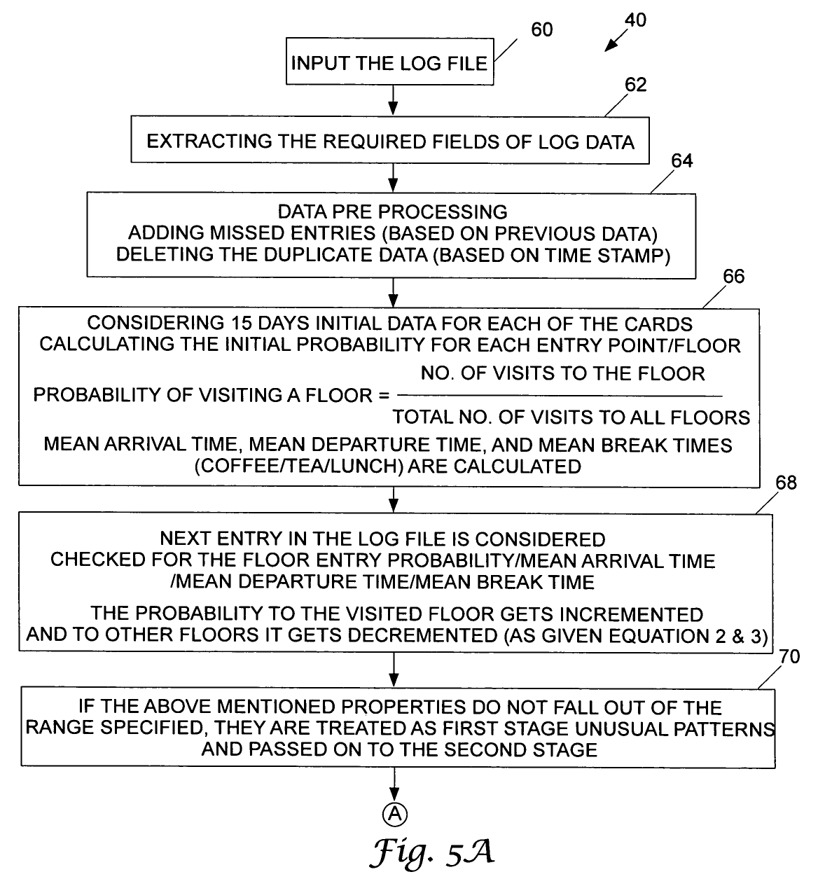

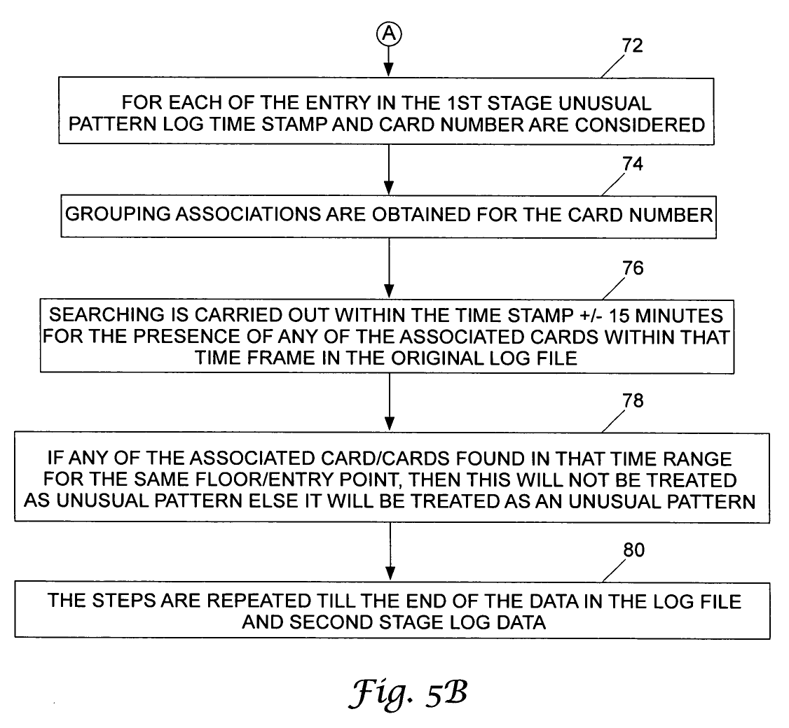

FIGS. 5A and 5B show the flow chart of FIG. 2 in additional detail. As shown in FIG. 5A, the data in the initial log file stored in the memory 19 is input at 60. The fields of the initial log file required for the remainder of the processing of FIGS. 5A and 5B are extracted at 62. Thus, only certain fields may be extracted from the initial log file in order to create the new log file. These extracted fields may pertain, inter alia, to restricted area (e.g., floor) information, date information, time information, and access control card ID information.

The data in the extracted fields is pre-processed at 64 in order to remove inconsistencies from the data. As described above by way of example, duplicate data can be eliminated, successive IN and OUT entries for the same access control card ID at the same instant in time can be eliminated, and missing IN and/or OUT entries in the log file may be supplied under certain circumstances such as those described above.

The pre-processed data is then analyzed at 66, 68, and 70 for unusual patterns. The analysis performed at 66, 68, and 70 is a probabilistic, statistical, and historical analysis. Accordingly, at 66, the probability that a card holder is visiting a corresponding restricted area, such as a floor, is calculated. As explained above, each visit by a card holder to a restricted area increases the probability that the card holder will in the future visit that restricted area and decreases the probability that the same card holder will visit other restricted areas.

At 68 of FIG. 5A, these probability calculations may be updated (incremented and decremented as appropriate) during subsequent periods of time using the equations disclosed above.

At 70, all entries in the initial log file are analyzed to detect unusual data patterns. As indicated above, the data in the log file is examined to determine whether any visits by card holders are to less probable restricted areas. Thus, if an entry of the initial log file relates to a visit by a particular card holder to a particular restricted area and if the probability of that visit as calculated above and discussed in connection with FIG. 4 is below a probability threshold, that entry will be entered into the new log file as an unusual pattern. As indicated above, the probability threshold is the square of the variance.

The data in the initial log file is also examined to determine (i) whether any visits by any card holders to any restricted areas were for unusual durations as compared to past visits by the card holders to those restricted areas, (ii) whether the arrival time of a card holder deviates from the mean arrival time for that card holder, (iii) whether the departure time of a card holder deviates from the mean departure time for that card holder, (iv) whether the break time for a card holder deviates from the mean break time for that card holder, etc. Any entries in the initial log file corresponding to any such deviations are also added to the new log file.

The new log file is then passed to the second stage processing shown in FIG. 5B. The card holder corresponding to a new log file entry currently being processed is designated as a card holder of interest. The second stage processing is executed in order to determine whether a card holder of interest has been engaged in a group activity involving group members who have moved through the same restricted area during the same times as card holder of interest. If so, the corresponding entry in the new log file can be removed from the new log file.

Accordingly, at 72, the time stamp and access control card ID for a first entry in the new log file is considered in detecting whether a group association exists. At 74 and 76, a group association is determined if the card holder of interest corresponding to this first entry have mover through in the same restricted areas during the same times (within ±15 minutes) as other card holders. As indicated at 78, if the card holder of interest associated with the first entry in the new log file is in such a group association, then the first entry in the new log file will not be treated as unusual pattern and will be removed from new the log file; otherwise, the first entry remains in the new log file and will be treated as an unusual pattern. At 80, the process returns to 72 to begin processing of the next entry in the new log file, and 72-80 are repeated until all entries in the new log file are so processed.

The entries in the new log file that remain after the processing of 72-80 correspond to suspicious behavior that can be further investigated to determine if the suspicious behavior amounts to fraudulent or improper behavior.

FIG. 6 is a high level flow chart of a program that can be executed by the controller 12 of FIG. 1 in order to detect group associations. The result obtained after executing the program represented in FIG. 6 is used for the blocks 74, 76, 78 & 80. The recognition of group associations between card holders is based on their access patterns, i.e., their movement into and out of restricted areas. These group associations are strengthened if substantially the same pattern appears repeatedly and are given less significance if substantially the same pattern does not appear repeatedly. These working groups of card holders can be dynamic, because their membership may change from time to time. Also, bigger working groups can be obtained from the merger of smaller subgroups. As indicated above, this group information is useful in sorting out unusual patterns in the log data.

Accordingly, at 90, the data from the pre-processed log file is input and, at 92, similar movement patterns are detected from this log data. Thus, if two or more card holders repeatedly enter and exit the same restricted areas at roughly the same times, it may be inferred that such card holders are engaged in a group work activity. At 94, these associations are grown based the common working patterns of future days. That is, each association (i.e., each group) may be weighted. For example, when an association is first formed, it may be given some small weight. As the same association is seen in subsequent days, the weight given to that association may be incremented (grown).

At 96, the final groupings are identified with their strengths after the passage of a sufficient amount of time. For example, the final groupings and their corresponding weights may be identified and calculated at the end of each day.

Strengths show how strong the groups are. If a group has a very low weight, then this group has less significance and is not a strong association. However, a group having a high weight value has more significance and is a stronger association. An unusual pattern associated with a strong group might be ignored because this pattern might be a usual pattern of the movement. However, an unusual pattern associated with a weak group might not be ignored.

FIG. 7 is a more detailed showing of the high level flow chart of FIG. 6. Accordingly, at 100, the data from the pre-processed log file is input and, at 102, the entries in the initial log file for a first day and the next day following the first day are considered for group associations. At 104, the data to be considered is segmented by restricted area, such as by floors. At 106, the access control card IDs are separated into different groups by time stamp within a predetermined tolerance such as 20 seconds, by restricted area, and by entry to and exit from the restricted areas. Thus, card holders entering into and exiting from the same restricted areas at about the same time can be grouped together. At 108, each of the groups formed at 106 is given a default strength of 1 because the group has been seen once already. The strength is increased by 1 for each time that the group is detected during a pass through 102-114.

At 110, the strength (weight) of the smallest group found at 106 is increased if this smallest group is found to be part of bigger groups also found at 106, the strength of the next larger group found at 106 is increased if this next larger group is found to be part of a still bigger group, and so on until all groups are processed. Accordingly, only groups larger than the group currently being processed are examined in order to determined whether to increase the strength of the group currently being processed. The size of the group is determined by the number of members on the group. Each time the strength of a group is increased (incremented), it is increased by a predetermined amount, such as 0.01.

At 112, the grouping data and corresponding strengths are updated to the main grouping table. At 114, a determination is made as to whether all days covered by the log entries have been processed at 102-114. If not, the first and next days are incremented by one, and flow returns to 102. If all days covered by the log entries have been processed at 102-114, the group associations and their corresponding strengths resulting from the processing at 102-114 are made available to 78 of FIG. 5B.

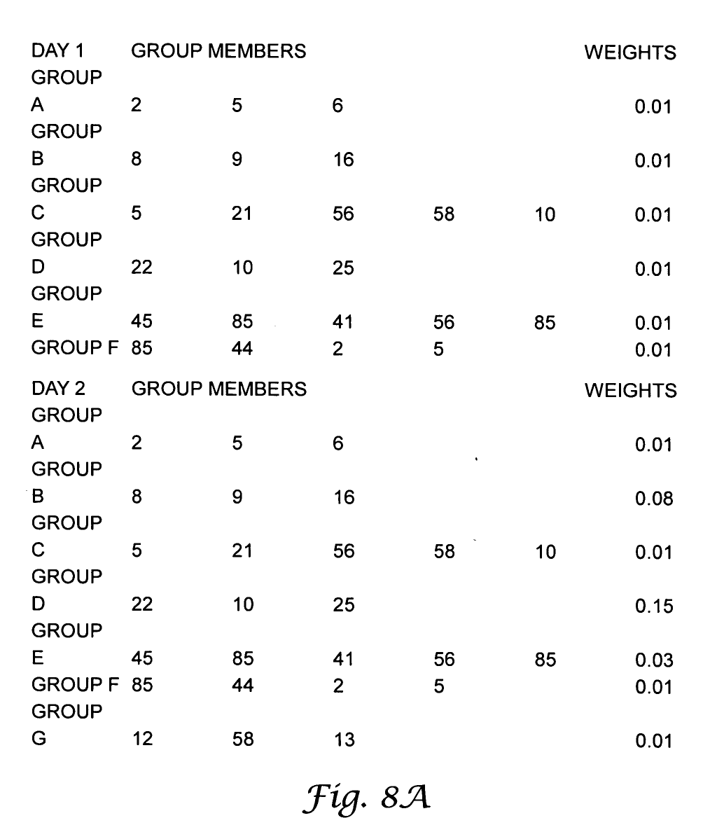

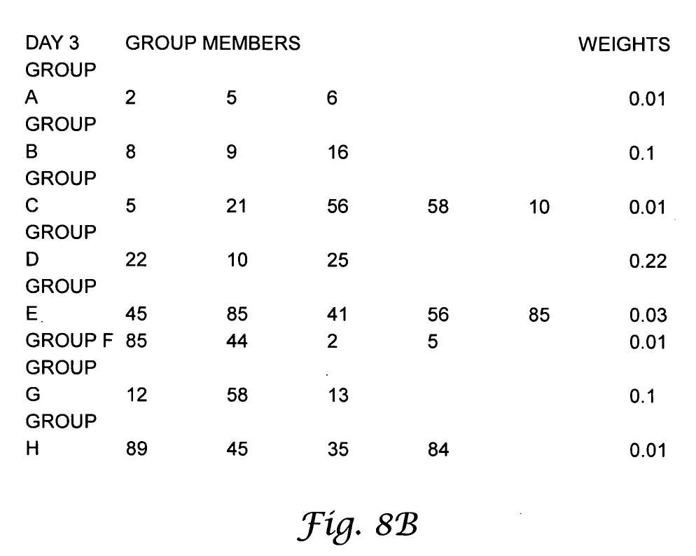

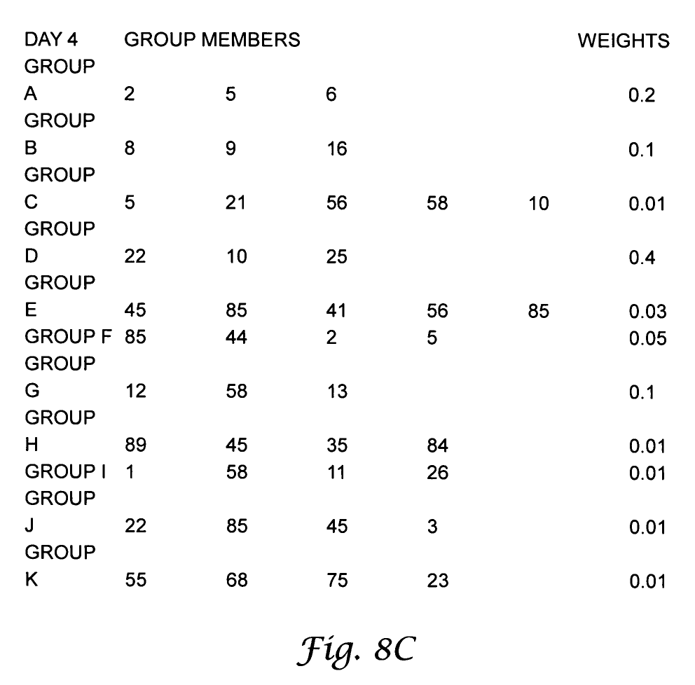

FIGS. 8A, 8B, and 8C illustrate an example of a grouping table that can be maintained. As shown in FIG. 8, the group constituencies and weights assigned to each group may change at the end of each day. When a group association is first detected, the weight assigned to this group association is given a small value. However, as the group association is subsequently detected, the value of the weight assigned to this group association may be incremented by a predetermined amount. For example, this weight may be incremented each n times that the group association is detected, where n≧1.

Alternatively, group associations may be obtained using association rules in the process described below. An association rule has two parts, a left hand side and a right hand side. The left hand side and the right hand side are sets of one or more card holders. Each association rule gives the confidence of finding right hand side card holders given left hand side card holders.

Association rules are used to discover patterns and correlations that may be buried deep inside a database. The entire process comprises preprocessing, preparation of transactions, finding frequent sets, and finding association rules.

The preprocessing involves the separation of entry and exit data by restricted area, such as by floor, and, if by floor, the separation of the data with respect to each entry and exit point in a floor, and the removal of multiple entries that are closely spaced together in.

The preparation of transactions (group associations) involves generating transactions or groups using a difference time threshold between a current entry and a previous entry, thus transactionalizing the data in the log file. The procedure for preparing transactions is given as follows:

```
begin
    Read the first record time t₁, Card Holder Id
        include Id in transaction T₁
        k : Current Transaction
    for each record in the database
        Read card holder Id and time tᵢ
        If (tᵢ − tᵢ₋₁) < time threshold {tᵢ₋₁ : previous
                record time}
            include Id in Tₖ
        else
            k = k + 1 {start next transaction}
            include Id in Tₖ
        endif
end
```

The frequent sets are found using the FP-Growth algorithm, where stands for Frequent Pattern. The objective here is to generate all combinations of items such that Support(item set)>min_sup.

The FP-Growth algorithm is a known algorithm and generally comprises following steps:

1. Scan the transactions database once, and find frequent 1-itemset (single item pattern);

2. Order the frequent items or transaction in frequency descending order;

3. Scan the transactions database again, construct FP-tree;

4. Mine for frequent patterns according to the order of items in FP-tree;

5. Generate candidate frequent patterns using set intersection operations;

6. Based on the candidate-frequent patterns set, construct conditional pattern bases for each node in the FP-tree;

7. Recursively mine the conditional FP-trees and grow frequent patterns obtained so far;

8. If the conditional FP-tree contains a single path, simply enumerate all the patterns.

Each card holder moves at least two times a day (arriving at and leaving a restricted area) so that 2 can be used as the minimum support for a one day database per point.

In finding the association rules, the frequent sets are used to generate the desired rules. A priori algorithms are used for generating the association rules. For example, if ABCD and AB are frequent sets, then one association rule can be generated by posing the rule that AB≧CD. In order to test this rule, the following ratio is computed:

conf=support(ABCD)/support(AB).

### If conf>min_conf (minimum confidence), then the rule holds. (The rule will surely have minimum support because ABCD is large).

Certain modifications of the present invention have been discussed above. Other modifications of the present invention will occur to those practicing in the art of the present invention. For example, the description above implies that the controller 12 controls access to an entire building. Instead, a building may be divided into zones with each zone having its own controller 12. Alternatively, there may be a master controller for the entire building and a separate zone controller for each of one or more zones of the building. As another alternative, the controller 12 may be arranged to control access to a group of buildings. Still other alternatives are possible.

Also, as described above, unusual data in an initial log file is moved during a first stage from the initial log file to the new log file, and the data in the new log file is processed in the second stage so as to remove any entries corresponding to group associations. Alternatively, instead of separating the unusual data from the initial log file and moving the unusual data to the new log file, the data in the initial log file can simply be given a tag identifying it as unusual data. If so, the tagged data can be considered to be a new log file even though that data is still stored in the initial log file.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A computer implemented method of processing access control data generated in connection with access control cards, the method comprising:
reading a log file containing data generated by an access control system that reads the access control cards in connection with restricted areas; and,
detecting unusual access patterns from the data in the log file.

2. The method of claim 1 wherein the reading of a log file comprises reading an initial log file containing data generated by an access control system that reads the access control cards in connection with restricted areas, wherein the method further comprises generating a new log file by processing the initial log file for consistency of the data contained in the initial log file and as a function of trends in the data contained in the initial log file, and wherein the detecting of unusual access patterns from the data in the log file comprises detecting unusual access patterns from the data in the new log file.

3. The method of claim 2 wherein the generating of a new log file comprises removing duplicate data.

4. The method of claim 2 wherein the generating of a new log file comprises supplying missing IN and OUT entries.

5. The method of claim 2 wherein the generating of a new log file comprises using some but not all of the fields of the initial log.

6. The method of claim 1 wherein the log file comprises an initial log file, and wherein the detecting of unusual access patterns from data in the log file comprises:
detecting group associations between card holders based on common movement of the card holders in connection with the restricted areas; and,
creating a new log file containing only those of the detected unusual access patterns that are not associated with the group associations.

7. The method of claim 3 further comprising computing a strength for each of the group associations and storing each strength with its corresponding group association.

8. The method of claim 1 wherein the detecting of unusual access patterns comprises detecting an unusual access pattern based on a visit by a card holder to one of the restricted areas not frequented by the card holder.

9. The method of claim 1 wherein the detecting of unusual access patterns comprises detecting an unusual access pattern based on a visit of unusual duration by a card holder to one of the restricted areas.

10. The method of claim 1 wherein the detecting of unusual access patterns comprises detecting an unusual access pattern based on a deviation from an usual arrival time by a card holder at one of the restricted areas.

11. The method of claim 1 wherein the detecting of unusual access patterns comprises detecting an unusual access pattern based on a deviation from an usual departure time by a card holder from one of the restricted areas.

12. The method of claim 1 wherein the detecting of unusual access patterns comprises detecting an unusual access pattern based on a deviation from an usual break time of a card holder.

13. A computer readable storage medium having program code stored thereon, the program code when executed performing the following functions:
generating a log file from data supplied by cards readers that read access control cards in connection with restricted areas;
computing probabilities of card holders entering the restricted areas, wherein the probabilities are computed based on the data in the log file; and,
detecting unusual access patterns based on the computed probabilities.

14. The computer readable storage medium of claim 13 wherein the function of computing of probabilities comprises the following functions:
incrementing or decrementing the probabilities as a function of entries to different restricted areas; and,
determining a variance based on the incremented or decremented probabilities.

15. The computer readable storage medium of claim 13 wherein the log file comprises an initial log file, and wherein the function of detecting of unusual access patterns from data in the log file comprises the following functions:
detecting group associations between card holders based on common movement of the card holders in connection with the restricted areas; and,
creating a new log file containing only those of the detected unusual access patterns that are not associated with the group associations.

16. The computer readable storage medium of claim 15 wherein execution of the program code comprises the further function of computing a strength for each of the group associations and storing each strength with its corresponding group association.

17. The computer readable storage medium of claim 13 wherein the function of detecting of unusual access patterns comprises the function of detecting an unusual access pattern based on a visit by a card holder to one of the restricted areas not frequented by the card holder.

18. The computer readable storage medium of claim 13 wherein the function of detecting of unusual access patterns comprises the function of detecting an unusual access pattern based on a visit of unusual duration by a card holder to one of the restricted areas.

19. The computer readable storage medium of claim 13 wherein the function of detecting of unusual access patterns comprises the function of detecting an unusual access pattern based on a deviation from an usual arrival time by a card holder at one of the restricted areas.

20. The computer readable storage medium of claim 13 wherein the function of detecting of unusual access patterns comprises the function of detecting an unusual access pattern based on a deviation from an usual departure time by a card holder from one of the restricted areas.

21. The computer readable storage medium of claim 13 wherein the function of detecting of unusual access patterns comprises the function of detecting an unusual access pattern based on a deviation from an usual break time of a card holder.

22. A computer implemented method of processing access control data generated in connection with access control cards, the method comprising:
generating a log file from the access control data supplied by cards readers that read the access control cards in connection with restricted areas;
computing probabilities of card holders entering the restricted areas, wherein-the probabilities are computed based on the data in the log file;
detecting unusual access patterns from the data in the log file based on the computed probabilities;
detecting group associations between card holders based on common movement of the card holders in connection with the restricted areas; and,
creating a new log file based on the detected unusual access patterns that are not associated with the group associations.

23. The method of claim 22 wherein the computing of probabilities comprises:
incrementing or decrementing the probabilities as a function of entries to different restricted areas; and,
determining a variance based on the incremented or decremented probabilities.

24. The method of claim 22 further comprising computing a strength for each of the group associations and storing each strength with its corresponding group association.

25. The method of claim 22 wherein the detecting of unusual access patterns comprises detecting an unusual access pattern based on a visit by a card holder to one of the restricted areas not frequented by the card holder.

26. The method of claim 22 wherein the detecting of unusual access patterns comprises detecting an unusual access pattern based on a visit of unusual duration by a card holder to one of the restricted areas.

27. The method of claim 22 wherein the detecting of unusual access patterns comprises detecting an unusual access pattern based on a deviation from an usual arrival time by a card holder at one of the restricted areas.

28. The method of claim 22 wherein the detecting of unusual access patterns comprises detecting an unusual access pattern based on a deviation from an usual departure time by a card holder from one of the restricted areas.

29. The method of claim 22 wherein the detecting of unusual access patterns comprises detecting an unusual access pattern based on a deviation from an usual break time of a card holder.
